(19) United States
(12) Patent Application Publication
(10) Pub. No.: US 2021/0285640 A1
(43) Pub. Date: Sep. 16, 2021

(54) NOZZLE WITH JET GENERATOR CHANNEL FOR FUEL TO BE INJECTED INTO A COMBUSTION CHAMBER OF AN ENGINE

(71) Applicant: Rolls-Royce Deutschland Ltd & Co KG, Blankenfelde-Mahlow (DE)

(72) Inventors: Max STAUFER, Berlin (DE); Carsten CLEMEN, Mittenwalde (DE)

(21) Appl. No.: 17/194,917

(22) Filed: Mar. 8, 2021

(30) Foreign Application Priority Data
Mar. 12, 2020 (DE) 102020106842.5

(51) Int. Cl. F23R 3/28; F02C 7/22

(52) U.S. Cl. CPC F23R 3/28; F05D 2240/36; F05D 2220/32; F02C 7/22

(57) ABSTRACT

The proposed solution relates to a nozzle for a combustion chamber of an engine for the purposes of providing a fuel-air mixture at a nozzle exit opening of the nozzle. The nozzle is, at a nozzle exit opening, formed with at least one guiding element for guiding a resulting fuel-air mixture radially outward with respect to the nozzle longitudinal axis and a center of the nozzle exit opening, and has, on the nozzle main body, at least one jet generator duct for generating at least one fuel jet which is directed radially inward and/or in the direction of a center of the nozzle exit opening.

This application claims priority to German Patent Application DE102020106842.5 filed Mar. 12, 2020, the entirety of which is incorporated by reference herein.

The invention relates to a nozzle for a combustion chamber of an engine for the purposes of providing a fuel-air mixture at a nozzle exit opening of the nozzle.

An (injection) nozzle for a combustion chamber of an engine, in particular for an annular combustion chamber of a gas turbine engine, comprises a nozzle main body which has the nozzle exit opening and which, aside from a fuel-guiding duct for conveying fuel to the nozzle exit opening, has multiple (at least two) air-guiding ducts for conveying air, which is to be mixed with the fuel, to the nozzle exit opening. A nozzle commonly also serves for swirling the supplied air, which is then, having been mixed with the supplied fuel, conveyed at the nozzle exit opening of the nozzle into the combustion chamber. Multiple nozzles are for example combined in one nozzle assembly, which comprises multiple nozzles arranged adjacent to one another, commonly along a circular line, for the purposes of introducing fuel into the combustion chamber.

Nozzles known from the prior art, for example from U.S. Pat. No. 9,423,137 B2 or U.S. Pat. No. 5,737,921 A, with multiple air-guiding ducts and with at least one fuel-guiding duct provide that a first air-guiding duct extends along a nozzle longitudinal axis of the nozzle main body and a fuel-guiding duct is situated radially further to the outside than the first air-guiding duct with respect to the nozzle longitudinal axis. At least one further air-guiding duct is then additionally provided radially further to the outside than the fuel-guiding duct with respect to the nozzle longitudinal axis. An end of the fuel-guiding duct, at which fuel flows out of the fuel-guiding duct in the direction of the air from the first air-guiding duct, is in this case typically situated, with respect to the nozzle longitudinal axis and in the direction of the nozzle exit opening, before the end of the second air-guiding duct, from which air then flows out in the direction of a mixture of air from the first air-guiding duct and fuel from the fuel-guiding duct. It is also known from the prior art, and for example also provided in U.S. Pat. Nos. 9,423,137 B2 or 5,737,921, for such a nozzle to be equipped with a third air-guiding duct, the possibly radially outwardly offset end of which follows the end of the second air-guiding duct in the axial direction.

It is also known from the prior art to provide, at an end, situated in the region of the nozzle exit opening, of an air-guiding duct situated radially at the outside, an air-guiding element for guiding air that flows out of the at least one further air-guiding duct. By means of an air-guiding element of said type, the commonly swirled air flowing out of the further air-guiding duct is diverted radially inward in order to achieve mixing with the fuel from the fuel-guiding duct and the additional air in particular from the 1st, inner air-guiding duct. In this way, it is sought to generate a spray cloud with fuel-air mixture, in which the fuel is present in finely distributed droplets.

In the case of nozzles known from practice, it has been found here that, under some circumstances, too much fuel evaporates already in the region of the end of the fuel-guiding duct and, consequently, zones which are strongly enriched with fuel are generated, which in turn lead to undesired soot emissions. In this context, it is proposed for example in EP 3 462 091 A1 to design the nozzle, in the region of the nozzle exit opening, such that an air flow from the air-guiding duct or the air-guiding ducts are configured, and coordinated with one another, such that a maximum flow-off angle, with respect to the nozzle longitudinal axis, at which air is conducted out of the air-guiding duct in the direction of the combustion chamber lies below 50°. In this way, improved scattering and distribution in particular of the liquid fuel in a radially outward direction with respect to the nozzle longitudinal axis and a center of the nozzle exit opening can be achieved.

Against this background, it is the object of the proposed solution to further improve a nozzle known from the prior art.

Said object is achieved by means of a nozzle according to claim 1.

According to said claim, a nozzle for a combustion chamber of an engine is proposed, in the case of which the nozzle comprises, on the nozzle main body, at least one additional jet generator duct for generating at least one fuel jet which is directed radially inward and/or in the direction of the center of a nozzle exit opening.

A proposed nozzle is thus formed, on the one hand, at the nozzle exit opening, with at least one guiding element for guiding a resulting fuel-air mixture radially outward with respect to the nozzle longitudinal axis and the center of the nozzle exit opening, wherein said fuel-air mixture is generated in particular by means of at least one first, inner air-guiding duct which extends along the nozzle longitudinal axis, by means of at least one fuel-guiding duct which is situated radially further to the outside than the first air-guiding duct, and by means of at least one further (second) air-guiding duct which is situated radially to the outside of the fuel-guiding duct. On the other hand, an additional jet generator duct is additionally provided for the purposes of enriching a zone close to the center at the nozzle exit opening with fuel. By means of the at least one fuel jet that can be generated by means of the at least one additional jet generator duct, it is thus possible for an inner recirculation zone in the region of the center of the nozzle exit opening to be enriched with fuel in a targeted manner. This can increase the stability of a flame formed as a result of ignition of the fuel-air mixture. Thus, whilst fuel injected via the fuel-guiding duct is predominantly (owing to the design of the nozzle and in particular of its at least one guiding element) mixed with air, and directed radially outward, at the nozzle exit opening, a fuel jet directed radially inwardly and/or in the direction of the center of the nozzle exit opening is provided by means of the at least one additional jet generator duct for the purposes of enriching an inner recirculation zone in the region of the center of the nozzle exit opening. A discrete fuel jet which is directed radially inward and/or in the direction of the center of the nozzle exit opening can thus be generated by means of the at least one additional jet generator duct.

A control device may be provided at the nozzle in order to actively control the generation of the at least one fuel jet, that is to say in particular to control this in a manner dependent on an engine state on the basis of various process parameters (for example with regard to the jet pressure) and possibly also initiate said generation only when required.

In one design variant, by means of the at least one jet generator duct, at least one fuel jet in a radially inward direction and/or in the direction of the center of the nozzle exit opening can be generated at the end of the inner air-guiding duct. The fuel jet that can be generated by means of the at least one jet generator duct can thus be generated in targeted fashion in the region of a rear end, which adjoins the nozzle exit opening, of the inner air-guiding duct. In this way, it can be ensured that the fuel injected via the jet generator duct is predominantly present only in the inner recirculation zone close to the center, without the guidance of the further fuel-air mixture radially outward, adhering to a maximum flow-off angle, being undesirably impaired as a result.

For example, the nozzle may have a further, third air-guiding duct which is situated radially further to the outside than the one further (second) air-guiding duct, such that a nozzle of said type has at least three air-guiding ducts via which air is provided at the nozzle exit opening. In one design variant, an edge of an exit opening of the jet generator duct is offset, along the nozzle longitudinal axis, with respect to an edge of an exit opening of the one further (second) air duct by at most a first spacing which corresponds to at most three times a second spacing by which the edge of the exit opening of the one further (second) air-guiding duct is offset, along the nozzle longitudinal axis, with respect to an edge of an exit opening of the third air-guiding duct. Thus, in this design variant, the exit openings of the air-guiding ducts and of the jet generator duct are present in close spatial proximity to one another in the region of the nozzle exit opening. In this way, the fuel-air mixture that is formed, and the flow thereof, can be influenced in targeted fashion and kept stable.

Alternatively or in addition, an exit opening of the fuel-guiding duct may extend on the nozzle main body in a circular arc shape or circular ring shape about the nozzle longitudinal axis. An exit opening, provided in the region of the nozzle exit opening, of the fuel-guiding duct thus has a circular-arc-shaped or circular-ring-shaped course. By contrast to this, an exit opening of the jet generator duct may be formed as a discrete circular opening on an inner lateral surface of the nozzle main body, which opening borders the first, inner air-guiding duct in order to generate a defined fuel jet which is directed radially inward and/or in the direction of the center of the nozzle exit opening and which is thinner than the air flows originating from the air-guiding ducts.

In one design variant, the jet generator duct and the fuel-guiding duct are connected to one another by means of a branching point within the nozzle main body. The jet generator duct and the fuel-guiding duct are thus fed by means of a common fuel supply within the nozzle main body, such that one proportion of the fuel conveyed via said fuel supply passes into the fuel-guiding duct, whereas another proportion passes into the jet generator duct. In particular, in this context, it may be provided that the jet generator duct and the fuel-guiding duct are fed with fuel from the same fuel system.

For the provision of a sufficient quantity of fuel via the jet generator duct in the recirculation zone close to the center at the end of the nozzle, one design variant may provide that an exit opening of the fuel-guiding duct has a cross-sectional area which corresponds to at least 8 times, in particular at least 10 times, a cross-sectional area of an exit opening of the jet generator duct. One or more exit openings, distributed over the circumference, of a fuel-guiding duct are thus larger than an exit opening of the jet generator duct by a factor of at least 8 or 10. In particular, a cross-sectional area, and thus an area through which flow passes, of an exit opening of the fuel-guiding duct may lie in a range from 8 times to 25 times the cross-sectional area of the jet generator duct. The following may thus apply for a cross-sectional area Aₛ of the jet generator duct in relation to a cross-sectional area A_{K} of a fuel-guiding duct: for example 8A_{S}≤A_{K}≤25A_{S}, in particular 10A_{S}≤A_{K}≤20A_{S}. An exit opening of the jet generator duct is thus several times smaller than an exit opening of the fuel-guiding duct.

Whereas it is basically possible for an exit opening of the jet generator duct to be provided on an inner lateral surface that borders the first, inner air-guiding duct, it is the case in one design variant that the at least one exit opening of the jet generator duct is alternatively provided on a central body which is situated within the inner air-guiding duct. In this way, it is for example possible for a fuel jet which is directed into the center to be generated already close to the center in the air-guiding duct by means of the jet generator duct (which runs within the central body).

In particular, by means of the axial spacing (measured along the nozzle longitudinal axis) of the central body or of the exit opening, provided thereon, of the jet generator duct to the nozzle exit opening, the size of a jet cone in which the fuel injected via the jet generator duct is present at the nozzle exit opening before said fuel impinges on the air flow that originates from the at least one further (second) air-guiding duct can be varied.

For example, the nozzle may extend with its nozzle main body with an overall length along the nozzle longitudinal axis, in the final third of which overall length exit openings of the air-guiding ducts of the nozzle are situated, whereas the at least one exit opening, provided on the central body, of the jet generator duct is present in a first or second third of the overall length. Consequently, in such a design variant, the central body within the first, inner air-guiding duct is, with the at least one exit opening of the at least one jet generator duct, offset relatively far axially forward (upstream) and thus spaced apart from the nozzle exit opening to a relatively great extent. In this way, it can for example be achieved that, at the end of the first, inner air-guiding duct, fuel injected via the jet generator duct centrally into the first, inner air-guiding duct is present so as to be distributed over the entire cross-sectional area, through which flow passes, of the inner air-guiding duct, and a relatively broad spray cone for the additionally injected fuel is thus present at the end of the first, inner air-guiding duct.

In an alternative design variant, the central body may however also be arranged with the exit opening of the jet generator duct in a final third of the nozzle main body in order, at the nozzle exit opening, to have a narrower jet cone for the fuel additionally injected in jet form.

Basically, the jet generator duct within the nozzle main body (that is to say in particular in a shell section for the first, inner air-guiding duct or in a central body in the first, inner air-guiding duct) may be fed with fuel from the same fuel supply as the fuel-guiding duct. Alternatively, different fuel supplies and thus different fuel systems are provided for the fuel-guiding duct under the jet generator duct within the nozzle main body.

The proposed solution is basically in particular combinable with a nozzle design as proposed in EP 3 462 091 A1. Accordingly, in one design variant, it is for example the case that an end of the fuel-guiding duct at the nozzle exit opening is bordered by a flow-off edge situated radially to the outside. The air-guiding element protrudes for example relative to said flow-off edge—with a defined length—in an axial direction in relation to the nozzle longitudinal axis such that
(a) a reference angle that is present between the nozzle longitudinal axis and a straight boundary line that runs through a (first) point at the flow-off edge and tangentially with respect to the axially protruding air-guiding element, and/or
(b) a reference angle that is present between the nozzle longitudinal axis and a straight reference line that runs through a (first) point at the flow-off edge and a (second) point of the air-guiding element which protrudes to a maximum extent in an axial direction beyond the flow-off edge,
   is less than or equal to 50°.

The flow-off edge of the fuel-guiding duct and the axially protruding air-guiding element of the air-guiding duct situated radially to the outside are in this case thus, in order to influence an air flow from the air-guiding duct, designed and coordinated with one another such that, by means of an axial protruding length of the air-guiding element, the one or more reference angles corresponding to the geometrical specifications given above are adhered to. Here, the reference angle according to the above-stated variant (a) and the reference angle according to the above-stated variant (b) may be identical. It is thus possible for one corresponding straight boundary line to satisfy, for example, both of the conditions stated above under (a) and (b), and to thus run both tangentially with respect to the axially protruding air-guiding element and in this case simultaneously through a point at the flow-off edge and a point of the air-guiding element which protrudes to a maximum extent in an axial direction beyond the flow-off edge.

By means of the proposed design of the flow-off edge and of the air-guiding element at the end of the nozzle, it can be achieved that, when the nozzle has been installed on the combustion chamber in the intended manner, a maximum flow-off angle with respect to the nozzle longitudinal axis at which air is conducted from the air-guiding duct in the direction of the combustion chamber is less than 50°. In particular, it can be achieved that said air is unconditionally conducted to the fuel-air mixture or the spray composed of fuel from the fuel-guiding duct and air from the first, inner air-guiding duct (and possibly from a further air-guiding duct that is situated between the inner air-guiding duct and the radially outermost air duct which has the air-guiding element at its end). By means of the proposed nozzle design, a maximum flow-off angle with respect to the nozzle longitudinal axis at which air is conducted from the air-guiding duct situated radially to the outside in the direction of the combustion chamber is less than 50°. In this way, the fuel consequently more effectively follows the flow path of the air which, in the case of multiple (at least two) air-guiding ducts situated radially to the outside, flows out of the radially outermost air-guiding duct of the nozzle. Thus, in one design variant, a fuel-air mixture which is generated in the central region at the end of the nozzle and in which the fuel is already present in a distributed manner in droplet form readily follows a flow path of the air flowing out of the air-guiding duct situated radially to the outside, such that the fuel in droplet form is directed radially outward to a greater degree and is more intensely mixed with air, leading to a more uniform distribution of the fuel and thus to a reduction of soot emissions.

The proposed arrangement and design of the axially protruding air-guiding element with regard to the flow-off edge is in this case initially basically independent of a geometry of the air-guiding element by means of which the air flowing out at the end of the air-guiding duct is guided radially inward. Accordingly, by means of the air-guiding element, it is furthermore possible for a minimum inner diameter of the nozzle exit opening to be defined, such that, by means of the (circumferentially encircling) air-guiding element situated radially to the outside, a narrowing of the nozzle exit opening (possibly combined with a widening, which follows downstream, of the nozzle exit opening toward the combustion chamber) is realized.

In one design variant, the straight boundary line runs tangentially with respect to the flow-off edge and tangentially with respect to the axially protruding air-guiding element. Here, the flow-off edge and air-guiding element of the nozzle are consequently designed and coordinated with one another such that the reference angle between the nozzle longitudinal axis and a straight boundary line which runs tangentially with respect to the flow-off edge and tangentially with respect to the air-guiding element is less than or equal to 50°.

In a refinement which is based on this and in which the air-guiding element has a radially inwardly pointing protuberance, the straight boundary line may furthermore run through a point on the air-guiding element which, in an axial direction, is situated behind the radially inwardly pointing protuberance of the air-guiding element. By means of the radially inwardly pointing, typically convex protuberance of the air-guiding element, the possibly swirled air which flows out of the air-guiding duct situated radially to the outside is conducted radially inward, such that an air flow from the air-guiding duct has a radially inwardly pointing directional component. The flow-off edge of the fuel-guiding duct and the air-guiding element are then designed geometrically to one another and/or arranged relative to one another such that the reference angle between nozzle longitudinal axis and the straight boundary line is less than or equal to 50°, wherein, then, the straight boundary line running tangentially with respect to the flow-off edge and tangentially with respect to the air-guiding element runs through a (reference) point on the air-guiding element which is situated behind or downstream of the inwardly pointing protuberance of the guiding element.

In the context of the proposed solution, it has for example proven particularly advantageous if the flow-off edge of the fuel-guiding duct and the air-guiding element lie on an outer lateral surface of a virtual, straight circular cone, the cone tip of which lies on the—centrally running—nozzle longitudinal axis and the opening angle of which corresponds to two times the reference angle. The flow-off edge and the air-guiding element of the air-guiding duct situated radially to the outside are in this case thus designed and coordinated with one another such that an axial end of the flow-off edge and the air-guiding element which protrudes axially beyond the end of the flow-off edge make (punctiform) contact with an outer lateral surface of such a virtual straight circular cone. Here, the flow-off edge and air-guiding element are consequently designed and arranged relative to one another such that, at the nozzle exit opening, the length with which an end of the air-guiding element protrudes relative to the flow-off edge of the fuel-guiding duct in an axial direction (pointing toward the combustion chamber in the installed state) is specified by means of a straight circular cone with an opening angle which corresponds to two times the specified reference angle and the cone tip of which lies on the (centrally running) nozzle longitudinal axis.

As part of the proposed solution, an engine having at least one proposed nozzle is also provided.

The appended figures illustrate, by way of example, possible design variants of the proposed solution.

In the figures:

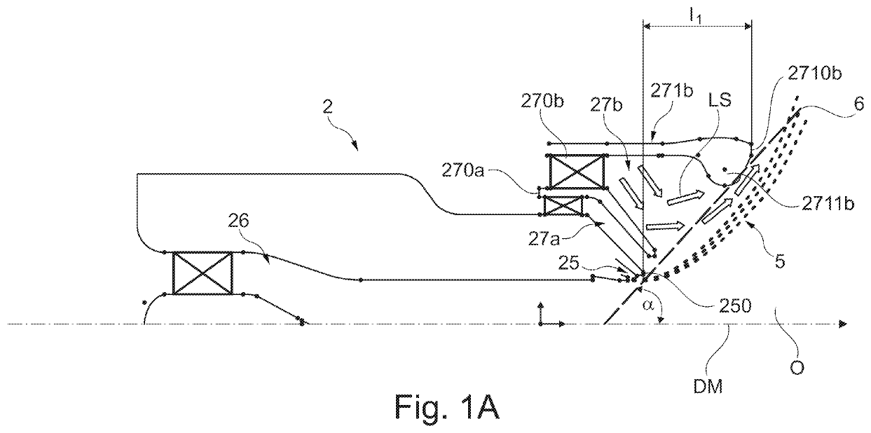

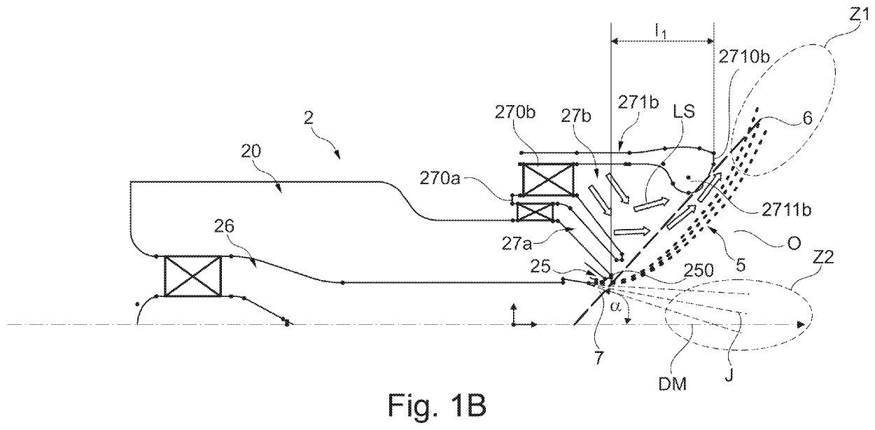

FIG. 1A shows a detail of a nozzle in the case of which flow guidance within a specified flow cone is attained by means of an air-guiding element, which protrudes axially with a defined length, of a radially outermost air-guiding duct;

FIG. 1B shows, in a view which corresponds to FIG. 1A, a refinement of the nozzle of FIG. 1A according to the proposed solution, such that at least one additional jet generator duct is provided at the end of an inner air-guiding duct for the purposes of generating at least one fuel jet which is directed into a center of a nozzle exit opening;

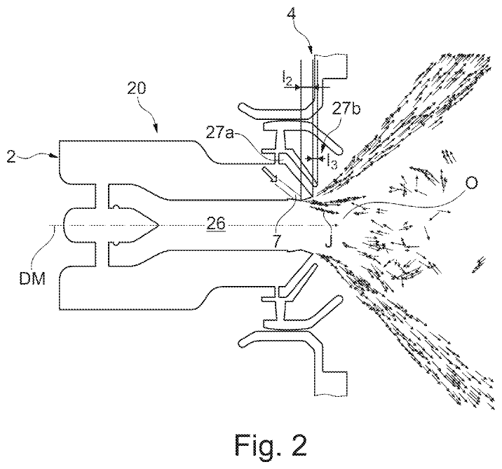

FIG. 2 shows, on the basis of the design variant of FIG. 1 B, a sectional illustration of a design variant of a proposed nozzle, illustrating the radially outwardly directed fuel-air flow and a flow close to the center, which results from the at least one additional fuel jet;

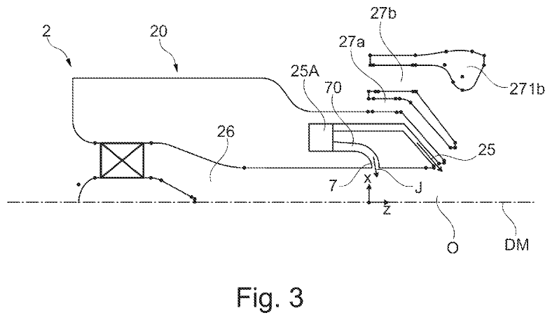

FIG. 3 shows, in an illustration corresponding to FIGS. 1A and 1B, a further design variant of a proposed solution, in the case of which a fuel-guiding duct and a jet generator duct of the nozzle are fed with fuel by means of the same fuel supply and thus the same fuel system within a nozzle main body;

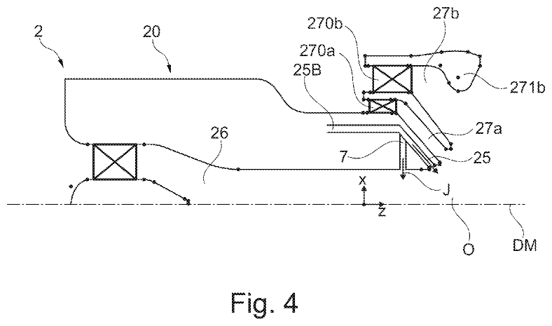

FIG. 4 shows, in a view corresponding to FIG. 3, a further design variant of a proposed nozzle, in the case of which a fuel-guiding duct and a jet generator duct are connected to one another by means of a branching point within the nozzle main body;

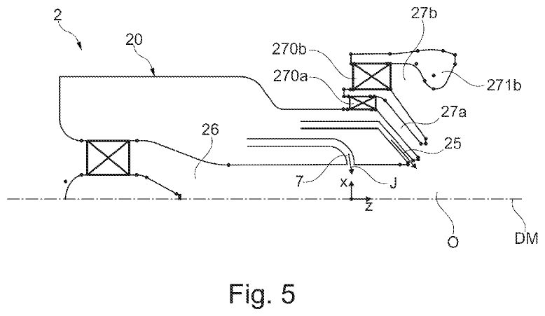

FIG. 5 shows, in a view corresponding to FIG. 4, a further design variant of a proposed nozzle, in the case of which a fuel-guiding duct and a jet generator duct are fed with fuel by means of different fuel supplies and therefore different fuel systems;

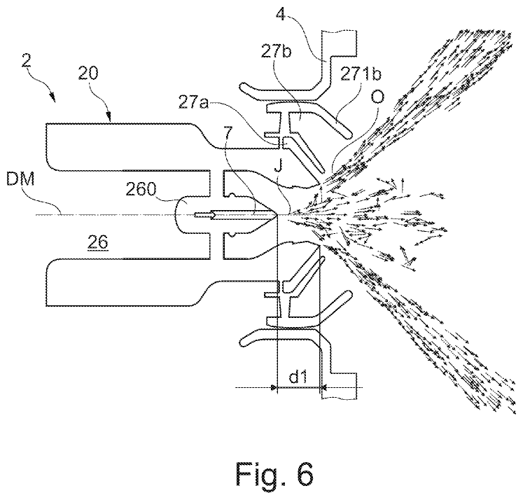

FIG. 6 shows, in a view corresponding to FIG. 2, a further design variant of a proposed nozzle with a jet generator duct for the injection of fuel close to the center, wherein the jet generator duct is provided on a central body arranged centrally within the inner air-guiding duct;

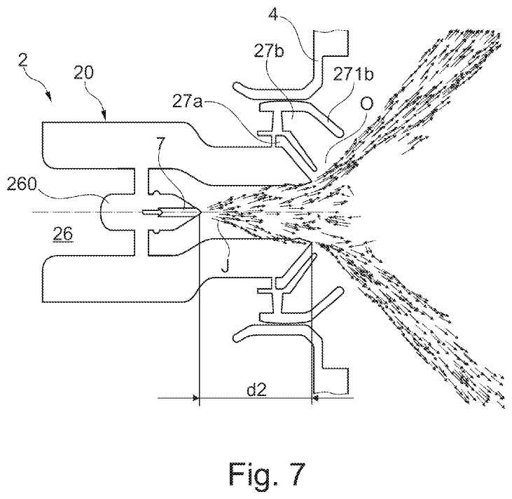

FIG. 7 shows, in a view corresponding to FIG. 6, a further design variant of a proposed nozzle, in the case of which the central body with the jet generator duct is, in relation to the design variant of FIG. 6, arranged further upstream in a first or second third of the overall length of the nozzle;

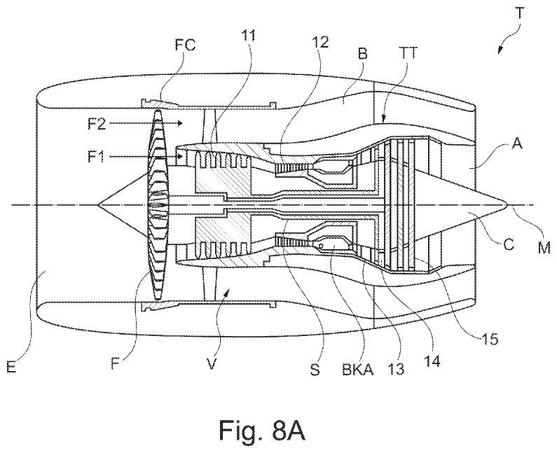

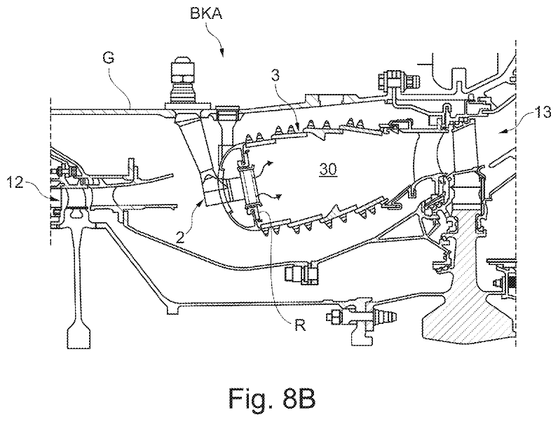

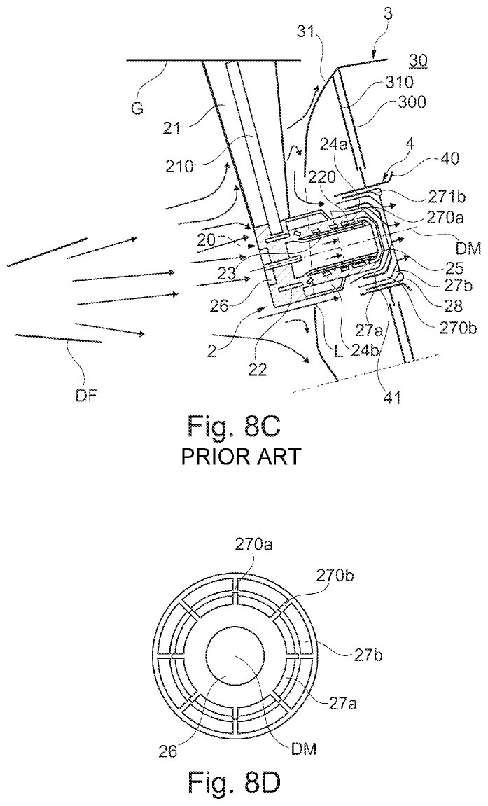

FIG. 8A shows an engine in which the design variants of FIGS. 1 to 7 is used;

FIG. 8B shows, in a detail and on an enlarged scale, the combustion chamber of the engine of FIG. 8A;

FIG. 8C shows, in a cross-sectional view, the basic construction of a nozzle according to the prior art and the surrounding components of the engine in the installed state of the nozzle;

FIG. 8D shows a rear view of a nozzle exit opening, with an illustration of swirling elements which are provided in air-guiding ducts, situated radially to the outside, of the nozzle.

FIG. 8A illustrates, schematically and in a sectional illustration, a (turbofan) engine T in which the individual engine components are arranged one behind the other along an axis of rotation or central axis M, and the engine T is formed as a turbofan engine. At an inlet or intake E of the engine T, air is drawn in along an inlet direction by means of a fan F. This fan F, which is arranged in a fan casing FC, is driven by means of a rotor shaft S which is set in rotation by a turbine TT of the engine T. Here, the turbine TT adjoins a compressor V, which comprises for example a low-pressure compressor 11 and a high-pressure compressor 12, and possibly also a medium-pressure compressor. On the one hand, the fan F conducts air in a primary air flow F1 to the compressor V, and, on the other hand, to generate thrust, in a secondary air flow F2 to a secondary flow duct or bypass duct B. The bypass duct B here runs around a core engine comprising the compressor V and the turbine TT and comprising a primary flow duct for the air supplied to the core engine by the fan F.

The air conveyed into the primary flow duct by means of the compressor V passes into a combustion chamber portion BKA of the core engine, in which the drive energy for driving the turbine TT is generated. For this purpose, the turbine TT has a high-pressure turbine 13, a medium-pressure turbine 14 and a low-pressure turbine 15. Here, the energy released during the combustion is used by the turbine TT to drive the rotor shaft S and thus the fan F in order to generate the required thrust by means of the air conveyed into the bypass duct B. Both the air from the bypass duct B and the exhaust gases from the primary flow duct of the core engine flow out via an outlet A at the end of the engine T. Here, the outlet A commonly has a thrust nozzle with a centrally arranged exit cone C.

FIG. 8B shows a longitudinal section through the combustion chamber section BKA of the engine T. This shows in particular an (annular) combustion chamber 3 of the engine T. A nozzle assembly is provided for the injection of fuel or an air-fuel mixture into a combustion space 30 of the combustion chamber 3. Said nozzle assembly comprises a combustion chamber ring R on which several (fuel/injection) nozzles 2 are arranged along a circular line around the central axis M. Here, on the combustion chamber ring R, there are provided the nozzle exit openings of the respective nozzles 2, which are situated within the combustion chamber 3. Here, each nozzle 2 comprises a flange by way of which a nozzle 2 is screwed to an outer casing G of the combustion chamber 3.

FIG. 8C now shows, in a cross-sectional view, the basic construction of a nozzle 2 and the surrounding components of the engine T in the installed state of the nozzle 2. Here, the nozzle 2 is part of a combustion chamber system of the engine T. The nozzle 2 is situated downstream of a diffuser DF and, during the installation process, is pushed through an access hole L through a combustion chamber head 31, through a heat shield 300 and a head plate 310 of the combustion chamber 3 to the combustion space 30 of the combustion chamber 3, such that a nozzle exit opening formed on a nozzle main body 20 extends into the combustion space 30. Here, the nozzle 2 is positioned on the combustion chamber 3 by way of a bearing section 41 of the combustor seal 4 and is held in a passage opening of the bearing section 41. The nozzle 2 furthermore comprises a nozzle stem 21 which extends substantially radially with respect to the central axis M and in which there is accommodated a fuel feed line 210 which conveys fuel to the nozzle main body 20. Also formed on the nozzle main body 20 are a fuel chamber 22, fuel passages 220, heat shields 23 and air chambers for insulation 23a and 23b. Additionally, the nozzle main body 20 forms a (first) inner air-guiding duct 26, which runs centrally along a nozzle longitudinal axis DM, and (second and third) outer air-guiding ducts 27a and 27b which are situated radially further to the outside in relation to said (first) inner air-guiding duct. Said air-guiding ducts 26, 27a and 27b extend in the direction of the nozzle exit opening of the nozzle 2.

Furthermore, at least one fuel-guiding duct 26 is also formed on the nozzle main body 20. Said fuel-guiding duct 25 is situated between the first, inner air-guiding duct 26 and the second, outer air-guiding duct 27a. That end of the fuel-guiding duct 25 via which fuel flows out of the first inner air-guiding duct 26 in the direction of the air during the operation of the nozzle 2 is, with respect to the nozzle longitudinal axis DM and in the direction of the nozzle exit opening, situated before an end of the second air-guiding duct 27a from which air from the second, outer air-guiding duct 27a flows out in the direction of a mixture of air from the first, inner air-guiding duct 26 and fuel from the fuel-guiding duct 25.

Swirling elements 270a, 270b are provided in the outer air-guiding ducts 27a and 27b for the purposes of swirling the air supplied via these. Furthermore, at the end of the third, outer air-guiding duct 27b, the nozzle main body 20 also comprises an outer, radially inwardly pointing air-guiding element 271b. In the case of the nozzle 2, which is for example a pressure-assisted injection nozzle, it is the case, correspondingly to FIG. 8C, that, with respect to the nozzle longitudinal axis DM and in the direction of the nozzle exit opening, that end of the fuel-guiding duct 25 from which fuel is supplied to the air from the first, inner, centrally extending air-guiding duct 26 during the operation of the engine T is followed by the ends of the second and third air-guiding ducts 27a and 27b situated radially to the outside. Air which has been swirled by means of the swirling elements 270a, 270b passes from said second and third air-guiding ducts 27a and 27b to the nozzle exit opening. As illustrated on the basis of the rear view of FIG. 8D in a view directed onto the nozzle exit opening along the nozzle longitudinal axis DM, said swirling elements 270a, 270b are arranged within the respective air-guiding duct 27a, 27b in a manner distributed over the circumference.

To seal off the nozzle 2 with respect to the combustion space 30, a seal element 28 is also provided on the circumference of the nozzle main body 20. Said seal element 28 forms a counterpart with respect to a combustor seal 4. Said combustor seal 4 is mounted in floating fashion between the heat shield 300 and the head plate 310 in order, in different operating states, to compensate radial and axial movements between the nozzle 2 and the combustion chamber 3 and ensure a reliable seal.

The combustor seal 4 commonly has a flow-guiding element 40 to the combustion space 30. Said flow-guiding element 40 serves, in conjunction with the third, outer air-guiding duct 27b on the nozzle 2, for desired flow guidance of the fuel-air mixture that forms from the nozzle 2, more specifically the swirled air from the air-guiding ducts 26, 27a and 27b, and the fuel-guiding duct 25.

A combustion chamber assembly known from the prior art, corresponding to FIG. 8C, can be disadvantageous with regard to the formation of soot emissions. For example, under some circumstances, the air flow that is conducted radially inward from the third air-guiding duct 27b via the air-guiding element 271b cannot lead to a desired homogeneous distribution of the fuel directly downstream of the nozzle exit opening. In particular, regions with too much excess fuel can arise directly in the region downstream of the fuel-guiding duct 25, which regions in turn lead to a generation of soot emissions.

Against this background, it is already known that, in order to influence an air flow LS from the third air-guiding duct 271b, a flow-off edge 250, which borders the end of the fuel-guiding duct 25 at the nozzle exit opening radially to the outside, and the air-guiding element 271b, which protrudes in an axial direction x along the nozzle longitudinal axis DM in relation to said flow-off edge 250, are designed and coordinated with one another such that a reference angle a between the nozzle longitudinal axis DM and a reference straight line 6 is less than or equal to 50°. Said straight boundary line 6 runs through a (first) point at the flow-off edge 250 (for example through a point at a flow-off margin of the flow-off edge 250) and tangentially with respect to the axially protruding air-guiding element 271b, in particular tangentially with respect to the flow-off edge 250 and tangentially with respect to the air-guiding element 271b, which guides the air flow LS initially radially inward. Alternatively or in addition, the straight boundary line 6 runs through a point at the flow-off edge 250 and a (reference) point, which protrudes to a maximum extent in an axial direction x beyond the flow-off edge 250, of a combustion-space-side end of the air-guiding element 271b.

In the case of the nozzle 2 illustrated in FIG. 1A, it is for example the case that the air-guiding element 271b protrudes with a specified length I₁ in an axial direction x beyond the flow-off edge 250 of the fuel-guiding duct 25 such that the straight boundary line 6, as a tangent to the flow-off edge 250 and a radially inwardly pointing protuberance 2711b of the air-guiding element 271b, encloses an angle α≤50° with respect to the centrally running nozzle longitudinal axis DM. The air flow LS originating from the third air-guiding duct 27b is thus guided on an inner contour 2710b of the axially protruding air-guiding element 271b in a radially outwardly pointing direction within a spray cone 5 which is approximated to a naturally resulting spray cone of the injected fuel from the fuel-guiding duct 25 and thus the generated fuel-air mixture. The air flow LS from the third air-guiding duct 27b is thus conducted by means of the air-guiding element 271b, which is thus arranged with respect to the flow-off edge 250 of the fuel-guiding duct 25, at the nozzle exit opening in a virtual straight circular cone, the cone tip of which lies on the nozzle longitudinal axis DM and the opening angle of which is 2a. Thus, in FIG. 1A, the straight boundary line 6 exhibits the course of an external lateral surface of said straight circular cone, on which the flow-off edge 250 and the air-guiding element 271b (in the region of its protuberance 2711b) lie.

By means of the thus selected design of the nozzle 2, the air flow LS is forced to follow a flow path with an outflow angle of less than 50°, such that the air from the third air-guiding duct 27b is unconditionally conducted to the radially outwardly flowing spray formed from the fuel from the fuel-guiding duct 25 and the swirled air from the first, inner air-guiding duct 26 and the second air-guiding duct 27a.

The resulting spray cone 5 is, in the case of the nozzle 2 of FIG. 1A, advantageous specifically with regard to the reduction of soot emissions. It may however arise that, correspondingly to the illustration in FIG. 1B, relatively little fuel is present in a central zone Z2 in the region of a center of a nozzle exit opening O of the nozzle 2, whereas a sufficient fuel-air mixture is present in a zone Z1 situated radially further to the outside at the edge of the spray cone 5, for which droplets of the fuel injected via the fuel-conducting duct 25 are entrained radially outward by means of the air flow LS of the second and third air-guiding ducts 27a and 27b. Leaning of the fuel-air mixture can thus occur in the zone Z2 close to the center, which forms an inner recirculation zone at and downstream of the nozzle exit opening O. However, if insufficient fuel is present in said recirculation zone Z2, this can adversely affect the flame stability.

Against this background, the design variant of FIG. 1B provides that, in the region of the end of the first, inner air-guiding duct 26, at least one jet generator duct 7 is present in a shell of the first, inner air-guiding duct 26 on the nozzle main body 20. An exit opening of said jet generator duct 7 is thus situated on an inner lateral surface of the first, inner air-guiding duct 26, in the present case with a small axial spacing to an exit opening of the second air-guiding duct 27a. By means of the jet generator duct 7, at least one additional fuel jet J which is directed into the center of the nozzle exit opening O can be generated in order to enrich the inner recirculation zone Z2 at and downstream of the nozzle exit opening O with fuel in targeted fashion.

It is basically also possible for multiple exit openings of one jet generator duct 7 or exit openings of multiple jet generator ducts 7 for the purposes of generating fuel jets J to be provided over a circumference of the lateral surface of the first, inner air-guiding duct 26 about the nozzle longitudinal axis DM.

In particular, an exit opening of a jet generator duct 7 can be of relatively small and circular form on the inner lateral surface of the nozzle main body 20 which borders the first, inner air-guiding duct 26. By contrast, an exit opening of the fuel-guiding duct 25 may for example be formed so as to run in a circular arc shape or circular ring shape about the nozzle longitudinal axis DM. An exit opening of the fuel-guiding duct 25 may thus for example be formed as a slot which runs in a circular arc shape or circular ring shape on the inner lateral surface of the first, inner air-guiding duct 26, whereas relatively small discrete, circular holes are formed on the inner lateral surface for the jet generator duct 7.

As illustrated in particular on the basis of the flow courses of FIG. 2, it is achieved by means of the generation of fuel jets J in the direction of the center of the nozzle exit opening O that (additional) fuel is present in the inner recirculation zone Z2 at and downstream of the nozzle exit opening O. In order to in this case targetedly specify and control the flows of fuel which is formed, or of the fuel-air mixture which is formed, specifically in the end region of the nozzle 2, exit openings of the jet generator duct 7 and of the first, second and third air-guiding ducts 26, 27a and 27b are in this case provided for example so as to be in close spatial proximity to one another. Accordingly, in the present case, an edge of an exit opening of the jet generator duct 7 is offset, along the nozzle longitudinal axis DM, with respect to an edge of an exit opening of the first air-guiding duct 27a by at most a first spacing I₂ which corresponds to at most three times a second spacing I₃ by which the edge of the exit opening of the second air-guiding duct 27a is offset, (axially) along the nozzle longitudinal axis DM, with respect to an edge of an exit opening of the third air-guiding duct 27b. The spacings I₂ and I₃ between the individual exit openings are thus in particular of the same order of magnitude, such that the exit openings are each present at one end of the nozzle 2.

In the design variants of FIGS. 3 to 5, a fuel jet J that can additionally be generated is directed radially inward to a greater degree, or exclusively radially inward, than in the design variant of FIGS. 1B and 2, which provides an oblique injection of additional fuel, with respect to the nozzle longitudinal axis DM, radially inward and in the direction of the center of the nozzle exit opening O.

In the design variant of FIG. 3, the jet generator duct 7 and the fuel-guiding duct 25 are fed by one and the same fuel system by means of a common fuel supply 25A, which runs within the nozzle main body 20. The fuel supply 25A thus feeds both a supply 70 for the jet generator duct 7 and the fuel-guiding duct 25. An exit opening of the fuel-guiding duct 25 is in this case provided in each case downstream of an exit opening of the jet generator duct 7. An axial spacing between the exit opening of the fuel-guiding duct 25 and an exit opening of the jet generator duct 27 is in this case several times greater than the spacings of the exit opening of the fuel-guiding duct 25 to the exit openings of the first, second and third air-guiding ducts 26, 27a and 27b. Furthermore, an exit opening of the fuel-guiding duct 25, which is formed for example as a slot running in encircling fashion about the nozzle longitudinal axis DM, is considerably larger than an exit opening of the jet generator duct 7, several of which may be provided so as to be distributed along the circumference about the nozzle longitudinal axis DM. For example, a cross-sectional area of an exit opening of the fuel-guiding duct 25 is larger by a factor of 10 to 20 than a cross-sectional area of an exit opening of the jet generator duct 7. It is thus possible by means of a smaller exit opening for an additional, radially inwardly directed fuel jet J with relatively high pressure to be generated, but nevertheless for the fuel-guiding duct 25 and the jet generator duct 7 to be fed via the same fuel system. Fuel which originates from the fuel-guiding duct 25 and which is injected at a relatively large exit opening of the fuel-guiding duct 25 downstream of an exit opening of the jet generator duct 7 can thus be more easily diverted by the air flow LS and entrained in a radially outward direction in droplet form, whereas, by means of the fuel jet J generated with relatively high kinetic energy, and the fuel additionally injected centrally by means thereof, a targeted enrichment of the inner recirculation zone Z2 is attained.

In the design variant of FIG. 4, it is likewise the case that the fuel-guiding duct 25 and the jet generator duct 7 are fed with fuel via a common fuel system. By contrast to the design variant of FIG. 3, it is the case in the design variant of FIG. 4 that a common supply duct 25B is provided, to which both the fuel-guiding duct 25 and the jet generator duct 7 are connected in an end region of the nozzle main body 20.

In the design variant of FIG. 5, the fuel-guiding duct 25 and the jet generator duct 7 are fed with fuel via separate supplies and thus via different fuel systems. It is thus possible for the fuel that is injected into the first air-guiding duct 26 in radially inwardly directed jet form via one or more jet generator ducts 7 to be targetedly charged with a different pressure than the fuel injected via the fuel-guiding duct 25. In particular, a feed of fuel into the jet generator duct 7 can be relatively easily controlled electronically independently of a feed of fuel into the fuel duct 25, the exit opening of which is situated downstream of an exit opening of the jet generator duct 7.

In the design variants of FIGS. 6 and 7, an additional fuel jet J is generated proceeding from a central body 260 provided within the first air-guiding duct 26. Here, the central body 260 is arranged centrally within the first, inner air-guiding duct 26 and has the jet generator duct 7. The fuel jet J emerging from an exit opening of the jet generator duct 7 is in this case present centrally within the first, inner air-guiding duct 26 and is directed in the direction of the nozzle exit opening O.

The design variants of FIGS. 6 and 7 differ with regard to the positioning of the central body 260 and thus in particular a position of the exit opening or of the multiple exit openings of a jet generator duct 7 within the first, inner air-guiding duct 26. Accordingly, in the design variant of FIG. 6, an exit opening is positioned with a spacing dl to the exit opening of the first, inner air-guiding duct 26 and of the second air-guiding duct 27a, said spacing being smaller than a spacing d2 in the design variant of FIG. 7. Whereas the central body 260 and thus the exit opening of the jet generator duct 7 of the design variant of FIG. 6 are thus situated in a final third of an overall length of the nozzle main body 20, the central body 260 and the exit opening of the jet generator duct 7 in the design variant of FIG. 7 are situated further upstream in a first or second third of the overall length.

Here, the size of a spray cone for the fuel attributable to the fuel jet J differs in a manner dependent on the position of the central body 260 and of an exit opening, formed thereon, of the jet generator duct 7. Accordingly, the central body 260 of FIG. 7, which is positioned further upstream, results in a spray cone with a greater opening angle. A spray cone attributable to the fuel jet J in the design variant of FIG. 6 widens to a lesser degree and thus concentrates more fuel within the inner recirculation zone Z2 at and downstream of the center of the nozzle exit opening O.

### LIST OF REFERENCE DESIGNATIONS

11 Low-pressure compressor
12 High-pressure compressor
13 High-pressure turbine
14 Medium-pressure turbine
15 Low-pressure turbine
2 Nozzle
20 Nozzle main body
21 Stem
210 Fuel feed line
22 Fuel chamber
220 Fuel passage
23 Heat shield
24a, 24b Air chamber
25 Fuel-conducting duct
250 Flow-off edge
25A Fuel supply
25B Supply duct
26 First air-guiding duct
260 Central body
270a, 270b Swirling element
2710b Inner contour
2711b Protuberance
271b Air-guiding element
27a Second air-guiding duct
27b Third air-guiding duct
28 Seal element
3 Combustion chamber
30 Combustion space
300 Heat shield
31 Combustion chamber head
310 Head plate
311 Bearing point
4 Combustor seal
40 Flow-guiding element
41 Bearing section
5 Spray cone
6 Tangent/straight boundary line
7 Jet generator duct
70 Supply
A Outlet
B Bypass duct
BKA Combustion chamber portion
C Outlet cone
d1, d2 Spacing
DF Diffuser
DM Nozzle longitudinal axis
E Inlet/Intake
F Fan
F1, F2 Fluid flow
FC Fan casing
G Outer casing
J Fuel jet
L Access hole
LS Air flow
I₁, I₂, I₃ Length/spacing
M Central axis / axis of rotation
O Nozzle exit opening
R Combustion chamber ring
S Rotor shaft
T (Turbofan) engine
TT Turbine
V Compressor
Z1, Z2 Zone
α Reference angle

1. A nozzle for a combustion chamber of an engine for the purposes of providing a fuel-air mixture at a nozzle exit opening of the nozzle, wherein the nozzle comprises a nozzle main body which has a nozzle exit opening and which extends along a nozzle longitudinal axis, and the nozzle main body furthermore comprises at least the following:
at least one first, inner air-guiding duct which extends along the nozzle longitudinal axis and which serves for conveying air to the nozzle exit opening,
at least one fuel-guiding duct which is situated radially further to the outside than the first air-guiding duct with respect to the nozzle longitudinal axis and which serves for conveying fuel to the nozzle exit opening, and
at least one further air-guiding duct which is situated radially to the outside of the fuel-guiding duct with respect to the nozzle longitudinal axis,
wherein the nozzle is, at the nozzle exit opening, formed with at least one guiding element for guiding a resulting fuel-air mixture radially outward with respect to the nozzle longitudinal axis and a center of the nozzle exit opening,
wherein
the nozzle comprises, on the nozzle main body, at least one additional jet generator duct for generating at least one fuel jet which is directed radially inward and/or in the direction of the center of the nozzle exit opening.

2. The nozzle according to claim 1, wherein, by means of the at least one jet generator duct, at least one fuel jet in a radially inward direction and/or in the direction of the center of the nozzle exit opening can be generated at the end of the inner air-guiding duct.

3. The nozzle according to claim 1, wherein the nozzle has a further, third air-guiding duct which is situated radially further to the outside than the one further air-guiding duct, and an edge of an exit opening of the jet generator duct is offset, along the nozzle longitudinal axis, with respect to an edge of an exit opening of the one further air-guiding duct at most by a first spacing which corresponds to at most three times a second spacing by which the edge of the exit opening of the one further air-guiding duct is offset, along the longitudinal axis, with respect to an edge of an exit opening of the third air-guiding duct.

4. The nozzle according to claim 1, wherein an exit opening of the fuel-guiding duct extends on the nozzle main body in a circular arc shape or circular ring shape about the nozzle longitudinal axis, whereas, for an exit opening of the jet generator duct, a circular hole with a cross-sectional area smaller than the exit opening of the fuel-guiding duct is formed on the lateral surface.

5. The nozzle according to claim 1, wherein an exit opening of the fuel-guiding duct has a cross-sectional area which corresponds to at least 8 times, in particular at least 10 times, a cross-sectional area of an exit opening of the jet generator duct.

6. The nozzle according to claim 1, wherein the jet generator duct and the fuel-guiding duct are connected to one another by means of a branching point within the nozzle main body.

7. The nozzle according to claim 1, wherein, within the inner air-guiding duct, there is provided a central body in which the jet generator duct runs and which has at least one exit opening of the jet generator duct.

8. The nozzle according to claim 7, wherein, by means of the at least one exit opening of the jet generator duct on the central body, the at least one fuel jet can be generated centrally along the nozzle longitudinal axis.

9. The nozzle according to claim 7, wherein the nozzle main body extends with an overall length along the nozzle longitudinal axis, in the final third of which overall length exit openings of the air-guiding ducts of the nozzle are situated, and the at least one exit opening, provided on the central body, of the jet generator duct is present in a first or second third of the overall length.

10. The nozzle according to claim 1, wherein the jet generator duct within the nozzle main body is fed with fuel from the same fuel supply as the fuel-guiding duct.

11. The nozzle according to claim 1, wherein the jet generator duct within the nozzle main body is fed with fuel from a different fuel supply than the fuel-guiding duct.

12. An engine having at least one nozzle according to claim 1.
